(19) United States
(12) Patent Application Publication
(10) Pub. No.: US 2026/0195518 A1
(43) Pub. Date: Jul. 9, 2026

(54) METHOD FOR SYSTEM FOR AUTOMATICALLY GENERATING THE DESIGN RULE DOCUMENT OF A SEMICONDUCTOR DEVICE

(71) Applicant: AIP Technology Corporation, Grand Cayman (KY)

(72) Inventors: Tung-Yang CHEN, Zhubei City (TW); Yu-An CHEN, ZhuBei City (TW); Chang-Lin WU, ZhuBei City (TW); Chu HSU, Zhubei City (TW)

(73) Assignee: AIP Technology Corporation, Grand Cayman (KY)

(21) Appl. No.: 19/187,128

(22) Filed: Apr. 23, 2025

(30) Foreign Application Priority Data
Jan. 7, 2025 (TW) 114100572

(51) Int. Cl. G06F 30/398; G01R 31/26; G06F 30/392; G06F 111/08; G06F 117/12; G06F 119/20

(52) U.S. Cl. CPC G06F 30/398; G01R 31/2601; G06F 30/392; G06F 2111/08; G06F 2117/12; G06F 2119/20

(57) ABSTRACT

A method for automatically generating a design rule document of a semiconductor device is performed by the processor of an electronic device. The method can predict a tested experimental design method that meets a device type, the number of experimental factors, and expected electrostatic protection capabilities, provide the levels of the experimental factors and the recommended parameter values of undesigned factors, thereby generating a test device template. A semiconductor layout is generated based on the test device template. Automated test and measurement, the analysis of measurement results, and the formulation of design rule documents are integrated to achieve the purpose of automatically generating design rules.

### BACKGROUND OF THE INVENTION

This application claims priority for the TW patent application no. 114100572 filed on 7 Jan. 2025, the content of which is incorporated by reference in its entirely.

### FIELD OF THE INVENTION

The present invention relates to a semiconductor design method, particularly to a method for automatically generating a design rule document of a semiconductor device.

### DESCRIPTION OF THE RELATED ART

In the semiconductor industry, new or improved processes usually require design of experiment by an IC design house. After wafers are manufactured by a wafer foundry, they are returned to the IC design house for testing, verification, and result analysis to determine whether assumptions made in the experiment are valid and to determine whether to modify the fabrication process based on the results of experimental analysis.

Design of experiment (DOE) is a method to study and deal with the relationship between multiple factors and response variables. Test verification: Use various test machines to test the product's functionality and reliability to ensure that the product can achieve the expected performance during mass production. Analysis of experimental results: Use statistical methods to analyze and predict the results obtained by DOE, so as to obtain the weight and interaction of each parameter on the overall performance, thereby serving as the basis for future design. These three processes applied to the design of electrostatic discharge protection (ESD) devices are used as independent events. There is no method to integrate them in a single system.

### SUMMARY OF THE INVENTION

Accordingly, in order to the foregoing deficiencies of the conventional technology and meet future needs, the present invention provides a method for automatically generating a design rule document of a semiconductor device. The specific architecture and the implementation method thereof will be described in detail below.

An objective of the present invention is to provide a method for automatically generating a design rule document of a semiconductor device, which uses an application program to perform design of experiment, test verification, and analysis of experimental results. The application program provides a complete associative database for storing various parameter values used for design of experiment, the recommended parameter values of experimental factors, etc., so that there is a basis for establishing test parameters and backfilling test results in the subsequent process. When generating a design rule document, the required data can be directly exported from the database and the design rule document of the semiconductor device (such as an electrostatic discharge protection device) is automatically generated.

Another objective of the present invention is to provide a method for automatically generating a design rule document of a semiconductor device, which converts designed factors into a combination of experimental design methods that is provided to subsequent experiments for designing semiconductor layouts.

In order to achieve the foregoing purposes, the present invention provides a method for automatically generating a design rule document of a semiconductor device. The method, performed by the processor of an electronic device, includes:
predicting a tested experimental design method from various experimental design methods based on a device type for designing a semiconductor device, the number of various experimental factors, and an experimental goal;
automatically providing the recommended parameter values of undesigned factors based on the experimental factors and the device type;
automatically generating a test device template based on the experimental factors and the recommended parameter values of the undesigned factors and allocating the plurality of test device templates to a layout space to output a layout file that is provided for manufacturing a device under test (DUT);
receiving measurement parameters, transmitting a test condition document that is able to be read by a test machine to the test machine, and receiving a test result caused by measuring the DUT based on the measurement parameters; and
analyzing the test result to provide a combination of parameters that is a recommended combination of parameters generated by the processor based on the test result and generating a design rule document based on the combination of parameters.

In an embodiment of the invention, the device type is implemented with a semiconductor physical model and the experimental factors are selected from designed factors that are stored in a database.

In an embodiment of the invention, the experimental design methods include Taguchi method, full factorial design, a fractional factorial design, and response surface methodology.

In an embodiment of the invention, the levels of the experimental factors are automatically provided when the tested experimental design method is predicted.

In an embodiment of the invention, the experimental factors, the levels of the experimental factors, and the recommended parameter values of the undesigned factors are converted into the experimental table of the tested experimental design method.

In an embodiment of the invention, in the step of providing the recommended parameter values of the undesigned factors, a neural network model is established based on the experimental factors stored in the database, the parameter value of each of the experimental factors, and an experimental result, the neural network model is trained based on the experimental factors and a goal value to generate a prediction model, the undesigned factors are inputted to the prediction model to obtain the recommended parameter values of the undesigned factors.

In an embodiment of the invention, the measurement parameters include the pin configuration, test mode, pulse voltage, measurement points, and leakage current evaluation values of the DUT.

In an embodiment of the invention, the measurement parameters are converted into the test condition document that is able to be read by the test machine.

Below, the embodiments are described in detail in cooperation with the drawings to make easily understood the technical contents, characteristics and accomplishments of the invention.

### BRIEF DESCRIPTION OF THE DRAWINGS

FIG. 1 is a diagram schematically illustrating a system using a method for automatically generating a design rule document of a semiconductor device according to an embodiment of the present invention;

FIG. 2 is a flowchart of a method for automatically generating the design rule document of a semiconductor device according to an embodiment of the present invention;

FIG. 3 is a diagram schematically illustrating codes for the parameters of designed factors stored in a database according to an embodiment of the present invention;

FIG. 4 is a flowchart of generating the recommended parameter values of undesigned factors according to an embodiment of the present invention;

FIG. 5 is a diagram schematically illustrating a user interface having a screen for inputting basic information, an experimental goal, and test conditions according to an embodiment of the present invention;

FIG. 6A and FIG. 6B are diagrams schematically illustrating experimental factors and levels converted into orthogonal tables according to an embodiment of the present invention, wherein FIG. 6A shows experimental parameters inputted by a designer and FIG. 6B shows an orthogonal table converted from experimental parameters by an application program; and

FIGS. 7A-7D are diagrams schematically illustrating the partial content of the design rule document of an electrostatic discharge device according to an embodiment of the present invention.

### DETAILED DESCRIPTION OF THE INVENTION

The technical solutions in the embodiments of the present invention will be clearly and completely described below with reference to the drawings in the embodiments of the present invention. Obviously, the described embodiments are parts of the embodiments of the present invention, not all of the embodiments. Based on the embodiments of the present invention, all other embodiments obtained by those skilled in the art without making inventive efforts should be included within the scope of the present invention.

It should be understood that, when used in this specification and the scope of the claims, the terms “comprising” and “including” refer to the presence of a stated feature, whole, step, operation, element, and/or component, but does not exclude the presence or addition of one or more other features, wholes, steps, operations, elements, components and/or combinations of these.

It should also be understood that the terms used in the specification of the present invention is only used to describe particular embodiments but not intended to limit the present invention. As used in this specification and the claims, the singular forms “a,” “an,” and “the” are intended to include the plural forms unless the context clearly dictates otherwise.

It should further be understood that the terms “and/or” used in the specification and the claims refer to any and all possible combinations of one or more of the associated listed items and include these combinations.

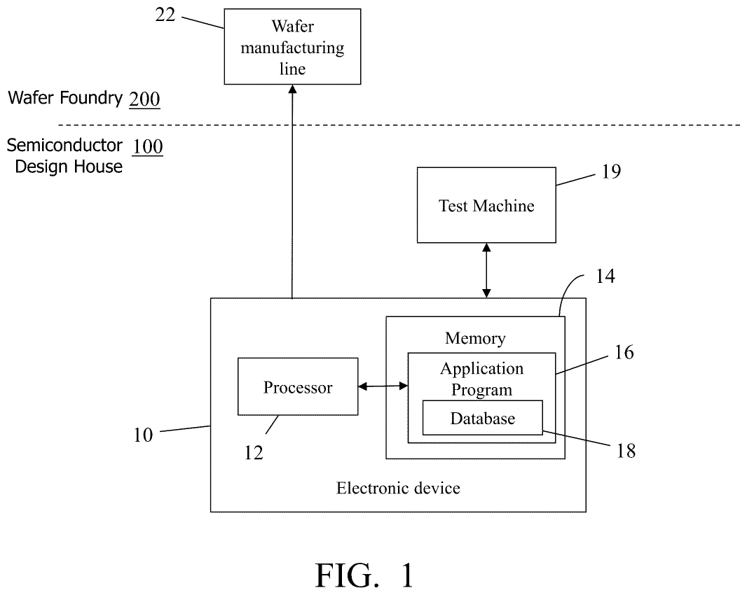

The present invention provides a method for automatically generating a design rule document of a semiconductor device. A system using the method for automatically generating a design rule document of a semiconductor device is shown in FIG. 1. A semiconductor design house 100 performs design of experiment on new or improved processes. After wafers are manufactured by a wafer foundry 200, they are returned to the semiconductor design house 100 for test verification and analysis of experimental results. Based on the results of the analysis, it is determined whether the assumptions made in the experiment are valid and whether to adjust the preset parameters or modify the process. In order to integrate design of experiment, test verification, and result analysis into the same process, the present invention constructs a large and complex system architecture. This architecture effectively improves the efficiency in storing, converting, and reading data, while significantly reducing the probability of error occurrence and ensuring the stability and accuracy of the overall process.

Please refer to FIG. 1. FIG. 1 is a diagram schematically illustrating a system using a method for automatically generating a design rule document of a semiconductor device according to an embodiment of the present invention. The method for automatically generating a design rule document of a semiconductor device of the present invention is performed by an electronic device 10 in the semiconductor design house 100. The electronic device 10 includes a processor 12 and a memory 14. The method for automatically generating a design rule document of a semiconductor device is implemented with an application program 16 installed in the memory 14 of the electronic device 10. In a preferred embodiment, the electronic device 10 may be a computer, a tablet computer, or a smart phone. Various parameters generated in the execution process of the present invention and various data received from the outside can be stored in a database 18 of the application program 16. The database 18 is established in the memory 14 of the electronic device 10. In one embodiment, various parameters generated in the execution process and various data received from the outside may also be stored in other hosts or cloud hard drives. By using the processor 12 of the electronic device 10 to perform the application program 16 in the memory 14, each step of the method for automatically generating a design rule document of a semiconductor device of the present invention can be performed. The steps are detailed as follows:

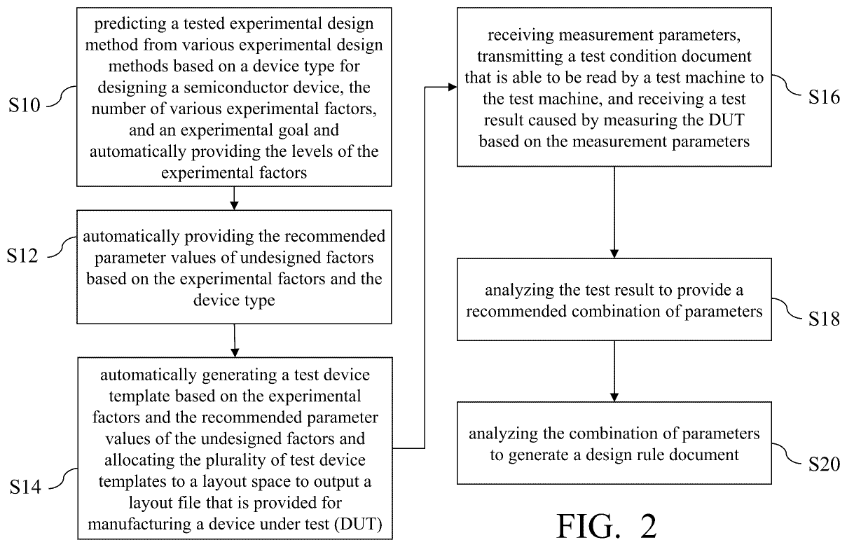

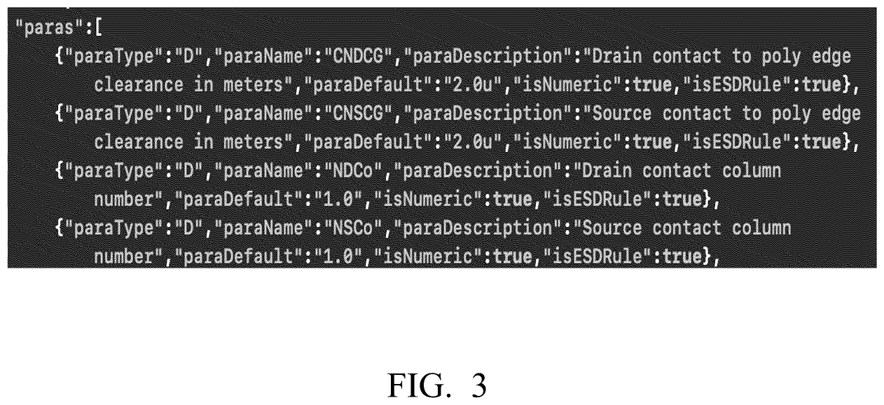

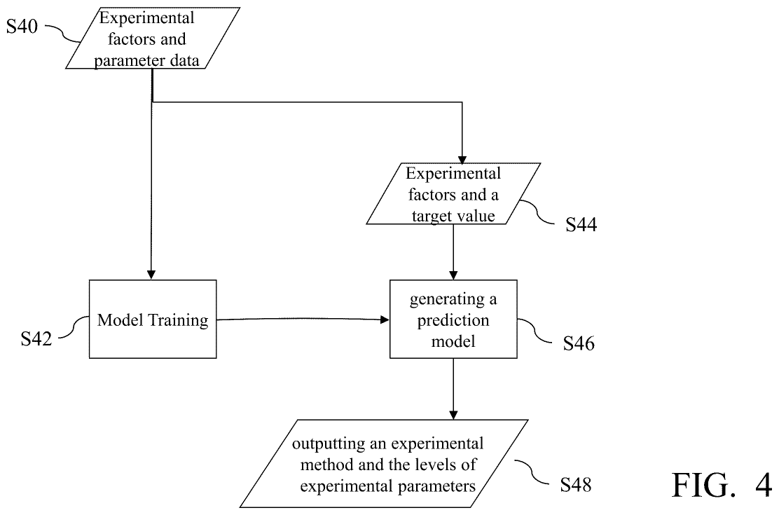

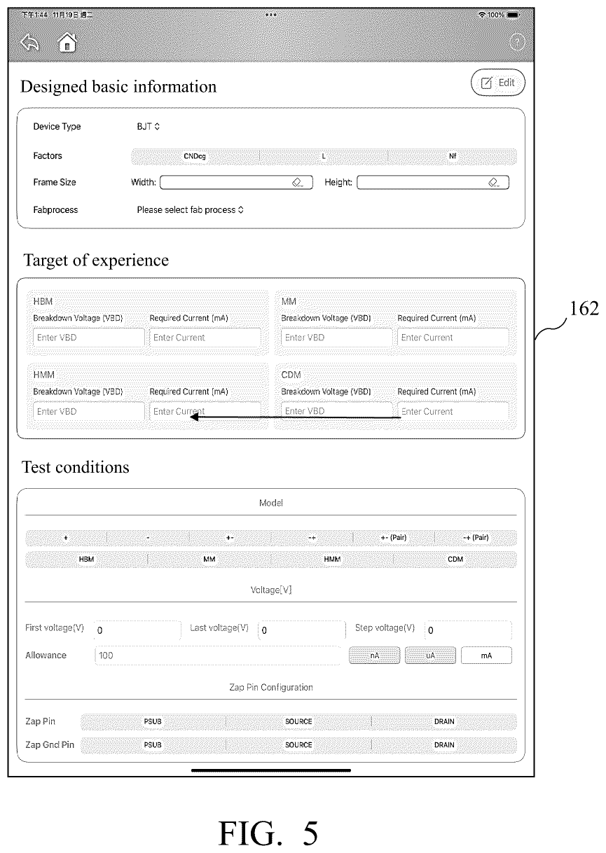

Please refer to FIGS. 1-5. FIG. 2 is a flowchart of a method for automatically generating a design rule document of a semiconductor device according to an embodiment of the present invention. FIG. 3 is a diagram schematically illustrating codes for the parameters of designed factors stored in a database according to an embodiment of the present invention. FIG. 4 is a flowchart of generating the recommended parameter values of undesigned factors according to an embodiment of the present invention. FIG. 5 is a diagram schematically illustrating the input screen of a user interface having a screen for inputting basic information, an experimental goal, and test conditions according to an embodiment of the present invention.

Before the process begins, the designer firstly selects the fabrication process related to the plan according to the requirements, selects a device type to be designed, and sets an experimental goal and test conditions, etc. according to the requirements, so as to establish an experimental plan. The experimental goal is to achieve the expected electrostatic protection capability of a device under test (DUT). Therefore, as shown in the user interface of FIG. 5 that includes input items such as a device type, experimental factors, a frame size, process selection, etc., the designer selects multiple experimental factors to be controlled in the user interface and stores them in the database 18. Then, as described in Step S10, a tested experimental design method is predicted from various experimental design methods based on a device type for designing a semiconductor device, the number of various experimental factors, and an experimental goal. In the specific prediction method, the application program 16 uses a prediction model to predict the levels of the recommended experimental factors and the experimental design method based on the parameter data of the experimental factors in the database 18 and transmits the levels of the recommended experimental factors and the experimental design method to the user interface for the designer to view. Since a designed device has a large number of parameters, the parameters other than the selected experimental factors are called undesigned factors. The recommended parameter values of the remaining undesigned factors are provided by the values in the database shown in FIG. 3. Therefore, in Step S12, the application program 16 automatically provides the recommended parameter values of multiple undesigned factors based on the experimental factors and the device type, and then automatically converts the experimental factors, their levels, and the recommended parameter values of the undesigned factors into an experimental table corresponding to the tested experimental design method. The term “automatically” in Step S12 means that the recommended parameter values of the undesigned factors are automatically generated to convert the experimental table after the tested experimental design method and the levels of the experimental factors are obtained in Step S10. Thus, the user does not need to press any key to run the application program 16. In Step S14, a test device template is automatically generated based on the experimental factors and the recommended parameter values of the undesigned factors and the plurality of test device templates are allocated to a layout space to output a layout file that is provided to a wafer foundry for manufacturing a wafer based on the layout file. The wafer is fabricated into a device under test (DUT) in the subsequent process. In Step S16, measurement parameters are received, a test condition document that is able to be read by a test machine is transmitted to the test machine, and a test result caused by measuring the DUT based on the measurement parameters is received. In Step S18, the test result is analyzed to provide a combination of parameters that is a recommended combination of parameters generated by the processor 12 based on the test result. In Step S20, a design rule document is generated based on the combination of parameters. Each step is detailed as follows:

In Step S10, the device type is implemented with a semiconductor physical model (such as MOS, BJT, etc.), and its corresponding designed factors (including experimental factors and undesigned factors) are stored in the database 18. Generally speaking, a customer (e.g., an electronics company) proposes performance requirements, such as electrostatic protection tolerance [using human body static test, human body model (HBM)/mechanical static test, machine model/charge and discharge test, charged device model (CDM), and other methods]. The semiconductor design house 100 establishes basic information (including a device type, a process used, foundry information, and performance requirements, etc.) about the experiment in the application 16 according to the contract with the customer. In addition to storing various semiconductor physical models, the database 18 also stores these designed factors. The semiconductor design house 100 selects designed factors that correspond to various semiconductor physical models from the database 18 built in the application program 16 as experimental factors and fills the designed factors into the application program 16. Next, the application program 16 performs Step S12. That is to say, based on the selected experimental factors and the device type, the recommended parameter values of undesigned factors are automatically provided. The experimental factors, their levels, and the recommended parameter values of the undesigned factors are converted into the experimental table of the tested experimental design method.

FIG. 3 is a diagram schematically illustrating codes for the parameters of designed factors stored in a database 18 according to an embodiment of the present invention. paraName represents the name of the designed factor, paraDescription represents the description of the designed factor, and paraDefault represents the recommended parameter value of the designed factor. After some designed factors used for the experiment are selected, their levels are automatically generated by the program, and the parameter values of the remaining undesigned factors are automatically brought out from the database 18.

The experimental design methods include Taguchi method, full factorial design, a fractional factorial design, and response surface methodology. Referring to FIG. 5, the experimental factors CNDcg, L, and Nf are selected from the designed factors. CNDcg represents the drain contact to poly gate clearance). L represents the channel length. Nf represents the channel finger number.

The application program 16 automatically generates level values and experimental methods based on the device type, the experimental goal, and the experimental factors using the algorithm of FIG. 4. FIG. 4 is a flowchart of generating the recommended parameter values of undesigned factors according to an embodiment of the present invention. As described in Steps S40~S42, a neural network model is established based on the experimental factors stored in the database 18, the parameter value of each of the experimental factors, and an experimental result. In Steps S44 and S46, the neural network model is trained based on the experimental factors and a goal value to generate a prediction model that is different from the prediction model in Step S10. The prediction model in Step S10 is used to predict the levels of the recommended experimental factors and the experimental design method. As described in Step S48, based on a designed factor selected by the designer, the prediction model generated in Step S46 will output the recommended value of the factor, namely the recommended parameter value of the undesigned factor.

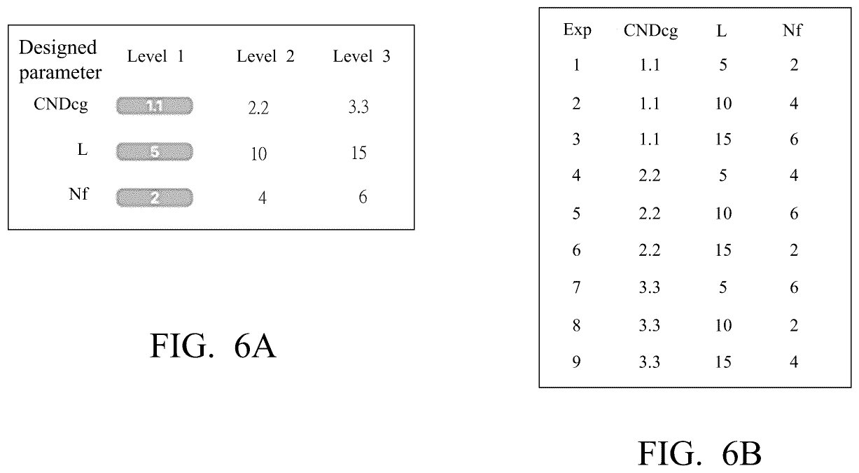

FIG. 6A and FIG. 6B are diagrams schematically illustrating experimental factors and levels converted into orthogonal tables according to an embodiment of the present invention. FIG. 6A shows experimental parameters inputted by the designer. In the case of level 1, the experimental factor CNDcg is 1.1, L is 5, and Nf is 2. The embodiment of FIG. 6A uses Taguchi method L9. Querying the orthogonal table of Taguchi method L9, {[1,1,1], [1,2,2], [1,3,3], [2,1,2], [2,2,3], [2,3,1], [3,1,3], [3,2,1], [3,3,2]} are obtained. These combinations are the results of looking up the orthogonal table of Taguchi method L9, as shown in Table 1. The CNDcg experimental value of 1.1 is used as level 1. The CNDcg experimental value of 2.2 is used as level 2. By the same token, all the levels are obtained. Then, the orthogonal table is generated according to the experimental factor values, as shown in FIG. 6B. Thus, various experimental parameters are derived from the experimental factors.

TABLE 1

| | Column No. | | |
|---|---|---|---|
| Experiment No. | 1 | 2 | 3 |
| 1 | 1 | 1 | 1 |
| 2 | 1 | 2 | 2 |
| 3 | 1 | 3 | 3 |
| 4 | 2 | 1 | 2 |
| 5 | 2 | 2 | 3 |
| 6 | 2 | 3 | 1 |
| 7 | 3 | 1 | 3 |
| 8 | 3 | 2 | 1 |
| 9 | 3 | 3 | 2 |

Assume that the experimental method recommended by the application program is the full factorial design. The experimental table generated includes a combination of experimental factors. Taking L=5, 10, 15, Nf=2, 4, 6 as an example, the generated orthogonal table includes 9 groups of experiments, namely L=5, Nf=2; L=5, Nf=4; L=5, Nf=6; L=10, Nf=2; L=10, Nf=4; L=10, Nf=6; L=15, Nf=2; L=15, Nf=4 and L=15, Nf=6.

In Step S12, the application program 16 automatically provides the recommended parameter values of the undesigned factors based on the experimental factors and the device type generated in Step S10. The orthogonal table and the recommended parameter values of all undesigned factors added to the orthogonal table form the experimental table.

In Step S14, the application program 16 automatically generates a test device template based on the experimental factors and the recommended parameter values of the undesigned factors included in the experimental table and designs an optimized space application layout based on die size to allocate the plurality of designed devices to die space. The layout of the die will be converted into a layout file in GDS format.

The layout file of the semiconductor layout can then be provided to the wafer foundry 200 and manufactured into a physical wafer through a wafer manufacturing line 22. When wafer manufacturing is completed, the application program 16 will receive wafer-related information, including the sizes of die, manufacturing versions, wafer batch numbers, and wafer numbers. During wafer manufacturing, the same frame is often used to form the same die on the wafers. The designers usually choose different die to perform multiple experiments to determine the accuracy of the experiments.

Next, the semiconductor design house 100 needs to place the die on a test machine 19 for testing to obtain the performance of each group of experimental products. After receiving multiple sets of test conditions, the application program 16 generates a test condition document that can be read by the test machine 19. After reading the test condition document, the test machine 19 finds the coordinates of the DUT and sets a series of measurement parameters to perform measurements on the individual device under test. After the test machine 19 completes the test, a test result will be generated. In a preferred embodiment of the present invention, the measurement parameters include the pin configuration, test mode, pulse voltage, measurement points, and leakage current evaluation values of the DUT, etc., wherein the setting for measurement points defines to examine the leakage currents of a measurement device in receiving different voltages and to evaluate the performance change by applying a specific voltage. The leakage current evaluation value is used as a key indicator to determine whether the DUT under different voltage conditions meets the design specifications or has been damaged.

After the application program 16 receives the test result, the test result is analyzed in Step S18. The application program 16 reviews various analysis results. The analysis items include detailed electrostatic discharge (ESD) capabilities and an analysis of the impact of various experimental factors on ESD capabilities. The application program 16 provides a combination of recommended parameters for the designer based on these analysis results to achieve an optimized ESD protection device design. This combination of parameters includes the device type (including a plan view and a cross-sectional view), the explanation of the name of each experimental factor, the recommended parameter values of undesigned factors, the test results of various combinations of parameters (including statistical analysis results and 3D curved surface plots, etc.), etc. These contents are written into the design rule document.

After generating the recommended parameter values of the experimental factor and the related results in Step S18 and before generating the design rule document in Step S20, the semiconductor design house 100 will determine whether the experimental results meet the assumptions made in the design of experiment and whether they can be used as design specifications based on the analysis and prediction data obtained by the application program 16. If the experimental results meet the assumptions, the process proceeds to Step S20. If the experimental results do not meet the assumptions, the initial experimental factors are recovered, the experiment is redesigned, and Step S10 is re-performed.

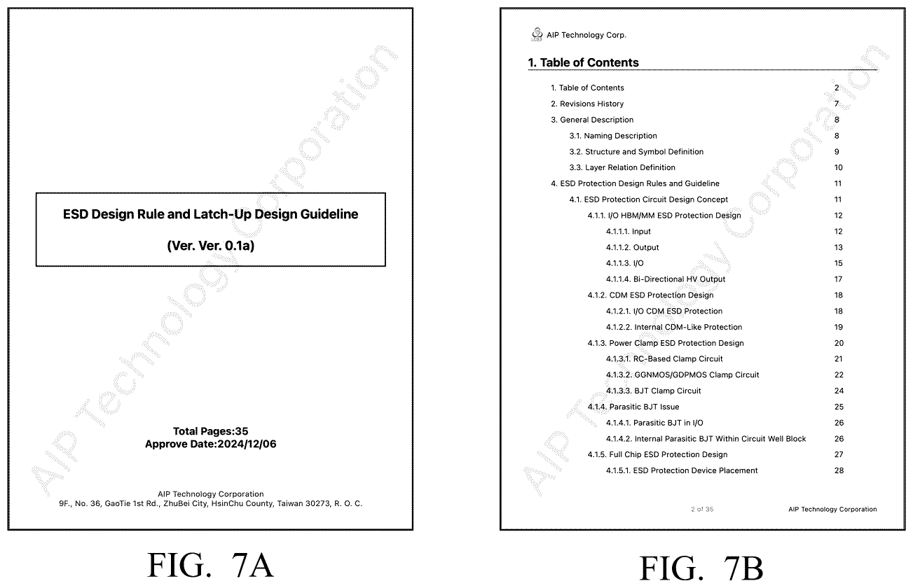

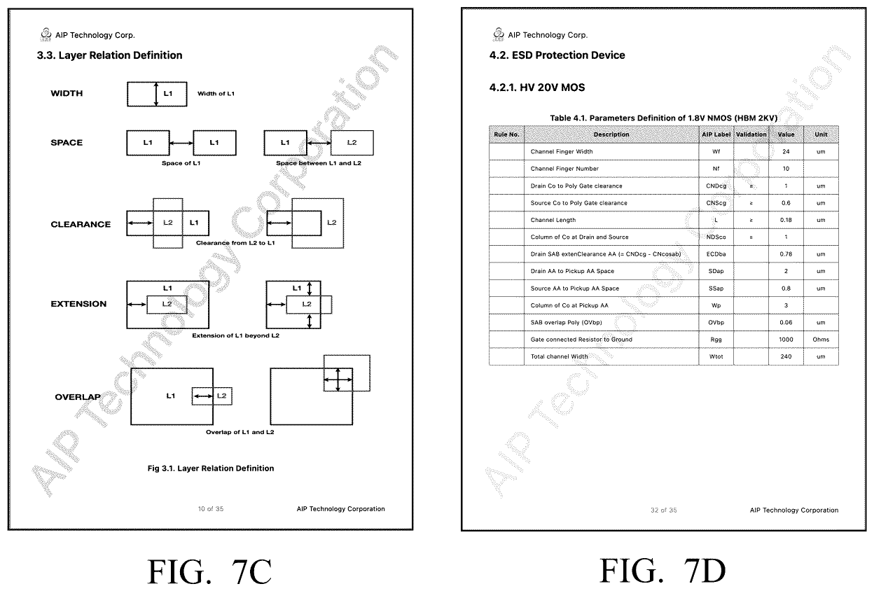

As illustrated in FIGS. 7A-7D, the design rule document is generated in Step S20. FIGS. 7A-7D are diagrams schematically illustrating the partial content of the design rule document of an electrostatic discharge device according to an embodiment of the present invention.

In conclusion, the present invention provides a method for automatically generating a design rule document of a semiconductor device. The method can predict an experimental design method that meets the device type, the number of the experimental factors, and the experimental goal from various experimental design methods and automatically provide the levels of the experimental factors. Based on the experimental factors, their levels, and the recommended parameter values of the undesigned factors provided by the application program, the layout design of the semiconductor structure is automatically generated. Using an algorithm, the designed devices are grouped and optimally sorted to maximize the efficiency of die space utilization. After the physical wafer is fabricated, the present invention automatically generates a measurement parameter file that can be read by the test machine for automated testing, analyzes the test result, and provides the optimal combination of experimental factors. Therefore, the present invention integrates all the processes into a single application program, including design of experiment for semiconductor layout, generation of measurement parameters after wafer fabrication, automated measurement, and analysis of measurement results to generate the design rule document. Without manually inputting the content of any document, a single application program can generate the design rule document of an electrostatic discharge (ESD) protection device.

The embodiments described above are only to exemplify the invention and not to limit the scope of the invention. Therefore, any equivalent modification or variation according to the shapes, structures, features, or spirit disclosed by the invention is to be also included within the scope of the invention.

What is claimed is:

1. A method for automatically generating a design rule document of a semiconductor device, performed by a processor of an electronic device, comprising:
predicting a tested experimental design method from various experimental design methods based on a device type for designing the semiconductor device, number of various experimental factors, and an experimental goal;
automatically providing recommended parameter values of undesigned factors based on the experimental factors and the device type;
automatically generating a test device template based on the experimental factors and the recommended parameter values of the undesigned factors and allocating a plurality of the test device templates to a layout space to output a layout file that is provided for manufacturing a device under test (DUT);
receiving measurement parameters, transmitting a test condition document that is able to be read by a test machine to the test machine, and receiving a test result caused by measuring the DUT based on the measurement parameters; and
analyzing the test result to provide a combination of parameters that is a recommended combination of parameters generated by the processor based on the test result and generating the design rule document based on the combination of parameters.

2. The method for automatically generating a design rule document of a semiconductor device according to claim 1, wherein the device type is implemented with a semiconductor physical model and the experimental factors are selected from designed factors that are stored in a database.

3. The method for automatically generating a design rule document of a semiconductor device according to claim 1, wherein the experimental design methods include Taguchi method, full factorial design, a fractional factorial design, and response surface methodology.

4. The method for automatically generating a design rule document of a semiconductor device according to claim 2, wherein levels of the experimental factors are automatically provided when the tested experimental design method is predicted.

5. The method for automatically generating a design rule document of a semiconductor device according to claim 4, wherein the experimental factors, the levels of the experimental factors, and the recommended parameter values of the undesigned factors are converted into an experimental table of the tested experimental design method.

6. The method for automatically generating a design rule document of a semiconductor device according to claim 2, wherein in the step of providing the recommended parameter values of the undesigned factors, a neural network model is established based on the experimental factors stored in the database, a parameter value of each of the experimental factors, and an experimental result, the neural network model is trained based on the experimental factors and a goal value to generate a prediction model, the undesigned factors are inputted to the prediction model to obtain the recommended parameter values of the undesigned factors.

7. The method for automatically generating a design rule document of a semiconductor device according to claim 1, wherein the measurement parameters include pin configuration, test mode, pulse voltage, measurement points, and leakage current evaluation values of the DUT.

8. The method for automatically generating a design rule document of a semiconductor device according to claim 1, wherein the measurement parameters are converted into the test condition document that is able to be read by the test machine.
